(19) United States
(12) Patent Application Publication
(10) Pub. No.: US 2005/0121396 A1
(43) Pub. Date: Jun. 9, 2005

(54) Apparatus and method for treating substances with electromagnetic wave energy

(76) Inventor: Darrell S. Kosakewich, Camrose (CA)

Correspondence Address: DONALD V. TOMKINS;C/O TOMKINS LAW OFFICE, 740, 10150 - 100 STREET, EDMONTON, AB, T5J 0P6, CA

(21) Appl. No.: 11/007,300

(22) Filed: Dec. 9, 2004

(30) Foreign Application Priority Data
Dec. 9, 2003 (CA) 2,452,733

(51) Int. Cl. B03C 1/00

(52) U.S. Cl. 210/748

(57) ABSTRACT

A method and apparatus are disclosed for treating a liquid with electromagnetic wave energy, particularly in the radio frequency range, wherein the characteristics of the wave energy are selected and controlled to produce optimally beneficial effects with respect to specific substances present in the liquid. The liquid to be treated is analyzed to identify its components, and an energy absorption value for a target component is determined. Electromagnetic wave signals, having characteristics selected to achieve a desired effect on the target component, are generated using a wave signal generator and then directed into the liquid using a wave signal emitter. The wave signal emitter may be in the form of an immersion probe or a transmitting antenna.

### FIELD OF THE INVENTION

The present invention relates to apparatus and methods for treating liquid, solid, and gaseous substances with electromagnetic wave energy to effect desirable changes in the properties and characteristics of the substance being treated, and in particular to apparatus and methods for treating liquids with electromagnetic waves in the radio-frequency range.

### BACKGROUND OF THE INVENTION

It is well known to treat liquids and other kinds of matter with electromagnetic wave energy to achieve a variety of beneficial effects, including eradication of pathogens, stimulation or enhancement of growth of desirable organisms, prevention or retardation of growth of undesirable organisms, elimination and prevention of hard water scaling, and enhancement of combustion efficiency of gasoline. Electromagnetic wave energy used in these prior art applications has included waves in the microwave, radio frequency, ultraviolet, X-ray, and gamma ray bands. In some prior art applications, treatment with electromagnetic wave energy has been combined with chemical treatment.

What is needed in this field is an improved method of treating a liquid with electromagnetic wave energy whereby the characteristics of the waves can be selected and controlled to produce optimally beneficial effects with respect to a target substance or component contained in the liquid being treated. For example, it may be desired to kill pathogenic microbes contained in a particular liquid, such as wastewater, drinking water, or industrial effluent. In another scenario, it may be desired to stimulate growth of beneficial microbial organisms, such as cellulose-producing cyanobacteria contained in a host liquid. In such situations, it would be desirable to be able to determine optimal electromagnetic wave energy characteristics for treating the liquid in question, based on the characteristics of the target organism. It would also be desirable to have apparatus for controllably generating electromagnetic waves having the optimal characteristics so determined, and for transmitting them to the liquid so as to achieve optimal exposure of the target organisms to the electromagnetic waves. The present invention is directed to the foregoing needs and desirable objectives.

### BRIEF SUMMARY OF THE INVENTION

In general terms, the present invention is in one aspect a system for analyzing a liquid to identify its components, determining an energy absorption value for one or more target components contained in the liquid, selecting electromagnetic wave characteristics (e.g., wave shape, wavelength, and frequency) optimally suited for having a desired effect on one or more target components, generating electromagnetic waves having such characteristics using wave signal generator means (such as a microcomputer having at least one programmable chip), and directing the waves into the liquid using a wave signal emitter. The wave signal emitter may be in the form of an immersion probe or an antenna-style transmitter, the latter having been found particularly beneficial for treatment of flowing liquids.

Accordingly, in one aspect the present invention is a method for treating a substance with electromagnetic wave energy, said method comprising the steps of:
(a) providing wave signal generator means adapted to generate constant-frequency and variable-frequency electromagnetic wave signals in the radio-frequency range;
(b) providing signal delivery means comprising:
   b.1 a pair of primary conductors electrically connected to the wave signal generator means; and
   b.2 a secondary conductor electrically connected to both primary conductors;
(c) providing signal emitter means associated with the secondary conductor;
(d) selecting one or more combinations of wave characteristics for a carrier wave signal of substantially constant frequency;
(e) selecting one or more combinations of wave characteristics for a variable-frequency wave signal;
(f) actuating the wave signal generator means to induce a carrier signal having the selected characteristics in one of the primary conductors;
(g) actuating the wave signal generator means to induce a variable-frequency signal having the selected characteristics in the other primary conductor; and
(h) engaging the signal emitter means with the substance to be treated, such that the substance is exposed to an output wave signal from the secondary conductor, said output signal being the combined form of the carrier wave signal and the variable-frequency wave signal.

In another aspect, the invention is a method for treating a colloidal dispersion so as to alter selected properties thereof, said method comprising the steps of:
(a) obtaining a sample of the colloidal dispersion to be treated;
(b) exposing the sample to a selected number of electromagnetic wave signals of varying frequencies, the sample being separately exposed to each wave signal for a selected exposure period;
(c) measuring and recording the zeta potential value of the sample at the end of each exposure period, with reference to the corresponding wave signal frequency;
(d) measuring the value of one or more selected properties of the dispersion at the end of each exposure period for each wave signal frequency;
(e) selecting a value for a selected property from the values measured in step (d);
(f) determining the zeta potential value corresponding to the dispersion property value selected in step (e), from the zeta potential values recorded in step (c);
(g) determining the wave signal frequency corresponding to the zeta potential value determined in step (f), from the wave signal frequencies recorded in step (c);
(h) exposing the colloidal dispersion to electromagnetic wave signals having frequencies approximately equal to the wave signal frequency determined in step (g); and
(i) measuring the zeta potential of the dispersion at selected time intervals until the measured zeta potential is approximately equal to the value determined in step (g).

In a further aspect, the invention is an apparatus for generating electromagnetic wave signals of selected characteristics, and introducing the wave signals into a liquid. In further aspects, the present invention is an apparatus and a method for treating gaseous substances with electromagnetic wave signals of selected characteristics, and an apparatus and a method for treating substantially solid substances with electromagnetic wave signals of selected characteristics. More generally in these aspects, the invention is an apparatus for treating a substance with electromagnetic wave signals, said apparatus comprising:
(a) wave signal generator means;
(b) signal delivery means comprising:
   b.1 a pair of primary conductors electrically connected to the wave signal generator means; and
   b.2 a secondary conductor electrically connected to both primary conductors; and
(c) signal emitter means associated with the secondary conductor; wherein:
(d) the wave signal generator means is controllable to generate electromagnetic wave signals of selected frequencies and amplitudes in the radio-frequency range;
(e) the wave signal generator means is capable of inducing a carrier wave signal of substantially constant frequency within the radio-frequency range in one of the primary conductors while inducing a variable-frequency wave signal within the radio-frequency range in the other primary conductor; and
(f) the carrier wave signal and the variable-frequency signal will combine to form an output signal carried by the secondary conductor to the signal emitter means.

### BRIEF DESCRIPTION OF THE DRAWINGS

Embodiments of the invention will now be described with reference to the accompanying figures, in which numerical references denote like parts, and in which:

FIG. 1 is a schematic depiction of the apparatus of the invention in accordance with a preferred embodiment.

FIG. 2 is a cross-section through a conduit schematically depicting the signal emitter means of the apparatus in accordance with an alternative embodiment, particularly adapted for treating liquids flowing within a conduit.

FIG. 2A is an enlarged detail of a flow vane of the signal emitter means of FIG. 2, showing the electrically-conductive element and non-conductive insulating element of the flow vane, and the connection of a secondary conductor to the electrically-conductive element in one embodiment.

### DETAILED DESCRIPTION OF PREFERRED EMBODIMENTS

1. Apparatus of the Invention

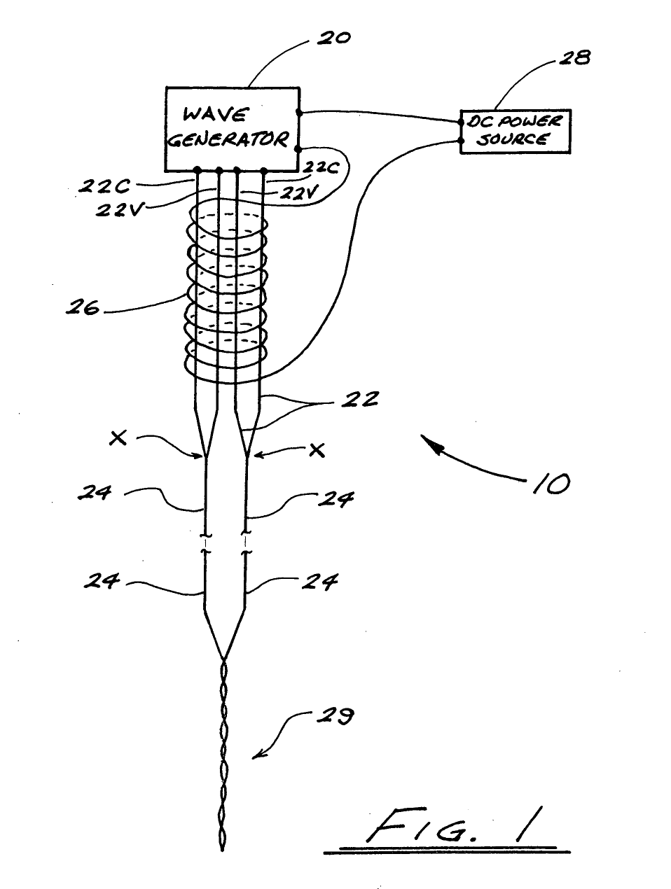

In one embodiment of the apparatus 10 of the invention, illustrated schematically in FIG. 1, wave signal generator means 20 generates a first wave signal having a selected and substantially constant frequency (the “carrier signal”), plus a second wave signal of variable frequency (the “variable signal”). The carrier signal and variable signal travel from the wave signal generator means through respective primary conductors 22C, 22V (preferably fashioned from insulated electrical wire).

At a connection point X a selected distance from the wave signal generator means 20, the primary conductors 22 are electrically connected to a secondary conductor 24 (preferably fashioned from insulated electrical wire). The carrier and variable signals thus pass from their respective primary conductors 22 into the secondary conductor 24, combining to form an output signal, which travels through the secondary conductor 24. Taken together, the primary conductors 22 and the secondary conductor 24 constitute a signal delivery means, for conveying wave signals from the wave signal generator means 20.

The carrier signal and variable signal will preferably be in the radio-frequency range, which is generally considered to cover waves having frequencies up to approximately 10,000,000,000 cycles per second. In preferred embodiments, the carrier and variable signals will be in the frequency range from 0 to 15,000 cycles per second, which may also be expressed as 0 to 15 kiloHertz (or kHz).

As illustrated in FIG. 1, the apparatus 10 may have two pairs of primary conductors 22, plus a secondary conductor 24 corresponding to each pair of primary conductors 22. In some embodiments, however, the apparatus 10 may have only one pair of primary conductors 22 and only one secondary conductor 24, while in other embodiments it may have three or more pairs of primary conductors 22 with corresponding secondary conductors 24. Where two or more pairs of primary conductors 22 are provided, the frequency of the carrier signal in one pair of primary conductors 22 may be different from that of the carrier signal in the other pair or pairs of primary conductors 22. Similarly, the frequency range of the variable signal in one pair of primary conductors 22 may be different from that of the variable signal in the other pair or pairs of primary conductors 22.

In one alternative embodiment, the primary conductors 22 are not directly connected to the wave signal generator means 20. Instead, the wave signal generator means 20 is remotely located, and carrier signals and variable signals are transmitted from the wave signal generator means 20 by means of either a hard-wired or wireless telecommunications network to a signal receiver (not shown), which in turn directs the carrier signals and variable signals to the appropriate primary conductors 22.

The apparatus 10 may include a coil 26 carrying a direct (i.e., DC) electric current from a DC power source 28. The coil 26 may be fashioned from insulated electrical wire. The DC current passing through the coil 26 creates a magnetic field in the vicinity of the coil 26. It has been observed that passing a conductor carrying a wave signal through a DC coil has the effect of orienting the wave signal as either a positive or negative signal, depending on the direction of the DC current running through the coil.

In the embodiment illustrated in FIG. 1, the apparatus has two pairs of primary conductors 22 passing through a single DC coil 26. In alternative embodiments, each pair of primary conductors 22 may pass through separate DC coils 26, or there may be more than two pairs of primary conductors 22 passing through a single DC coil 26. In other alternative embodiments, one or more DC coils 26 may be provided for individually surrounding separate primary conductors 22, such that the polarity of the carrier signal and variable signal carried in one pair of primary conductor 22 may be selectively and differentially controlled. In still further embodiments, individual primary conductors 22 or secondary conductors 24, or two or more primary conductors 22 or secondary conductors 24, may pass through two or more DC coils 26.

Although FIG. 1 shows a DC coil 26 encircling the primary conductors 22, this is not essential to the invention. The desired effect of controlling the orientation of the output signal may also be achieved by positioning a DC coil 26 around a portion of one of more secondary conductors 24. In alternative embodiments, one DC coil 26 may be positioned so as to surround portions of one or more secondary conductors 24 as well as portions of their respective primary conductors 22.

In preferred embodiments, the apparatus 10 also includes means (not shown) for selectively changing and/or alternating the polarity of the DC current running through the coil 26 or coils 26, thereby facilitating selective signal orientation as may be desired to suit particular applications or uses of the apparatus 10. As will be readily appreciated by persons skilled in the art of the invention, the means for changing polarity may be selected from suitable known means for changing the polarity of a DC current. In the embodiment shown in FIG. 1, the DC power source 28 also provides power to the wave signal generator means 20. In other embodiments, the wave signal generator means 20 and the coil 26 may have separate power sources.

The apparatus 10 of the present invention also includes signal emitter means, for delivering or transmitting signals from the one or more secondary conductors into a liquid or other substance to be treated. The signal emitter means may be provided in a variety of forms. For example, it may be an immersion probe for immersion in a liquid, whereby wave signals can propagate directly from the probe into the liquid. Alternatively, the signal emitter means may be a transmitting antenna that may be oriented toward the substance being treated from a convenient distance away, such that wave signals from the antenna will radiate into the substance. Both immersion probes and transmitting antennas may be used effectively for treating both static and flowing liquids. However, it has been observed that antenna-type signal emitter means may be particularly effective for treating flowing liquids.

In one particularly simple form, the signal emitter means is an immersion probe in the form of the secondary conductor itself. Preferably, however, the immersion probe will be a separate probe element made of an electrically-conductive material and electrically connected to the secondary conductor 24. The probe element may be encased in a protective casing made of a material (e.g., glass, plastic, or ceramic) that will not interfere significantly or at all with the propagation of wave signals from the probe, and that preferably will have low susceptibility to damage or deterioration from contact with the particular liquid being treated.

In the embodiment illustrated in FIG. 1, wherein the apparatus of the invention has two pairs of primary conductors 22 and therefore two secondary conductors 24, the secondary conductors 24 are braided (as generally indicated by reference numeral 29), without electrical interconnection, to form the signal emitter means in the form of an immersion probe (preferably with protective encasement as previously described).

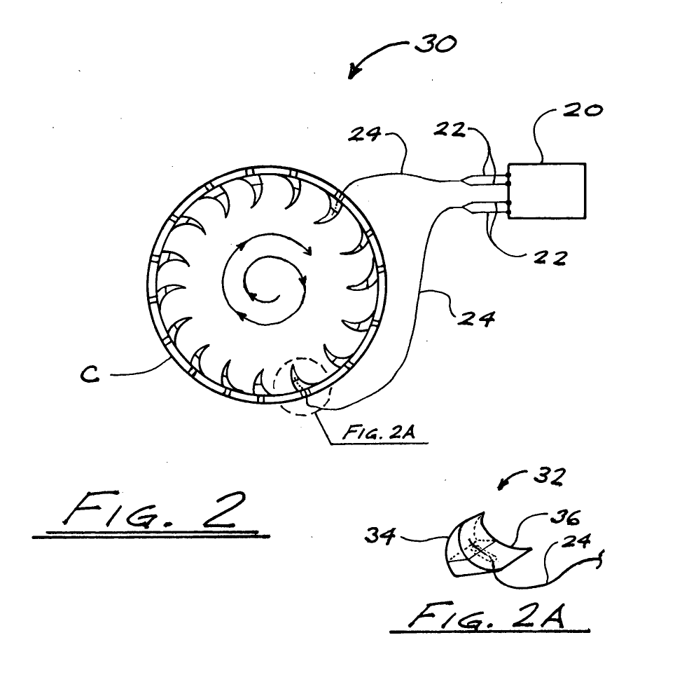

FIG. 2 illustrates an embodiment of the apparatus using a particular type of signal emitter means 30 especially adapted for use in treating liquids contained in a vessel or flowing inside a conduit C, such as a pipeline. A plurality of stationary flow vanes 32 are installed on the interior perimeter of the conduit C, said flow vanes 32 preferably being of arcuate or other appropriate form such that they will induce spiralling or otherwise swirling flow of the liquid as it passes by the vanes 32 (as conceptually indicated by the spiral arrows in FIG. 2). At least one and preferably several of the vanes 32 will have an electrically-conductive element 34 connected to a secondary conductor 24 carrying an output signal. These electrically-conductive elements thus serve as the signal emitter means, for transmitting or propagating output signals from the electrically-conductive elements into the fluid flowing through the conduit C.

As shown in FIG. 2 and FIG. 2A, each flow vane 32 having an electrically-conductive element 34 also has a non-conductive insulating element 36 for insulating the electrically-conductive element from the wall of the conduit C. However, these insulating elements are not required where the conduit C is fabricated from a non-electrically-conductive material.

By inducing swirling liquid flow in the conduit C, the flow vanes 32 have the effect of enhancing the extent and intensity of exposure of liquid to electromagnetic wave energy from the output signals. Beneficial effects may be achieved using different numbers of vanes 32, and with different numbers of the vanes 32 serving the function of signal emitters. No minimum number of vanes 32 are required, and not all vanes 32 necessarily need to serve as signal emitters. However, the effectiveness of the signal emitter means of this particular embodiment of the invention will be generally greater as the number of vanes 32 is increased (thus enhancing the inducement of swirling liquid flow), and as the number of vanes 32 serving as signal emitters is increased (thus increasing the range and intensity of exposure of the liquid to the output signals from the apparatus).

Although FIG. 2 illustrates a single wave signal generator means 20 with secondary conductors 24 connected to flow vanes 32 mounted inside the conduit C, it will be readily appreciated that in this and other embodiments of the invention any convenient number of wave signal generator means 20, each generating one or more output signals, may be used without departing from the fundamental concept and principles of the invention.

In alternative embodiments, the signal emitter means may be a transmitting antenna fashioned by wrapping one or more primary conductors 22 or secondary conductors 24 around a carbon rod, which will preferably be copper-coated. Although transmitting antennas may be effectively used for treating a liquid with electromagnetic wave signals, as previously mentioned, this form of signal emitter means will have particular applicability in the treatment of solid or substantially solid substances, as well as gaseous substances.

The foregoing are only a few examples of the types of signal emitter means which may be used with the present invention, the scope of which is not intended to be limited to or by these particular examples. It will be readily apparent to persons skilled in the art that various other well-known types of signal emitter means may be conveniently adapted for use as part of or in conjunction with the present invention. It will also be readily appreciated that multiple emitter means may be used; e.g., multiple immersion probes, multiple transmitting antennas, or combinations or one or more immersion probes and one or more transmitting antennas.

It has been observed that beneficial effects may be achieved by introducing the output signals into the substance being treated in an intermittent (or “pulsed”) fashion. For example, when using the apparatus of the invention to kill pathogenic organisms in wastewater, using an immersion probe as the signal emitter means, it has been found that the immersion probe may become coated with debris (which is thought to possibly comprise carcasses of organisms which have been killed). This debris coating can have a detrimental effect on the propagation of output signals from the probe. However, it has been discovered that pulsing the output signals can have the effect of causing this debris coating to slough off of the probe, or even preventing it from building up to any substantial extent at all.

Accordingly, the preferred embodiment of the apparatus of the present invention includes pulsing means (not shown), providing the ability to emit pulsed output signals as may be desired, at selected pulse intervals. The pulsing means may be any of numerous means well known in the field of electromagnetic wave generation and transmission. The pulsing means may be operable in association with the wave signal generator means 20 or the primary conductors 22, such that the carrier signals and variable signals are pulsed, thus causing the output signals to be pulsed. Alternatively, the pulsing means may be operable in association with the secondary conductors 24, such that the desired pulsing characteristics are imparted only to the output signals. In the preferred embodiment, the pulsing means is adapted to pulse the output signals randomly, in accordance with known techniques.

### 2. Method of the Invention—First Embodiment

In a first method according to the present invention, a liquid to be treated is first analyzed to determine its constituent components, using known means of spectral analysis such as chromatography, nuclear magnetic resonance (NMR) spectroscopy, or magnetic resonance imaging (MRI). In the preferred embodiment of the method, spectral analysis is carried out using gas chromatography and NMR spectroscopy.

Once the spectral analysis has been completed, the next step is to compare the results against a spectral analysis for a known control sample. The differences between these spectral analyses can then be used to identify constituents present in the liquid to be treated, but not present in the control sample.

The next step in the method is to select a target contaminant or constituent, and determine its energy absorption frequency (or “EAF”). An EAF for a particular constituent may be defined as a frequency of vibration at which the constituent, when subjected to wave energy having such frequency, will be affected in a particular way. For instance, there may be an EAF that kills a particular pathogenic microbe, or there may be an EAF that stimulates growth of a particular organism. There may be EAFs that induce, reduce, or prevent precipitation of a particular inorganic contaminant from hard water or industrial effluent. EAFs are already known for a large number of organisms and other substances, but additional EAFs may be determined experimentally.

The next steps in the method are to provide a programmable electromagnetic wave signal generating apparatus having wave signal emitter means, to program the apparatus to generate electromagnetic wave signals corresponding to the EAF of the target contaminant or constituent, and then to introduce the wave signals into the liquid by means of the signal emitter means. The wave signal generating apparatus may comprise a selected one or more of the previously-described embodiments of the apparatus of the invention. Accordingly, the invention contemplates embodiments of the method corresponding to each of the previously-described embodiments of the apparatus of the invention.

In alternative embodiments, the method of the invention may include the steps of determining harmonic frequencies corresponding to integral multiples of the EAF of a target constituent, generating electromagnetic wave signals (i.e., output signals) corresponding to one or more selected harmonic frequencies, and then introducing the harmonic output signals into the liquid by means of the signal emitter means, either instead of or in combination with output signals corresponding to the EAF.

In the preferred embodiment, the method includes the step of emitting the output signals in intermittent or pulsed fashion, and the wave signal generation apparatus includes pulsing means for this purpose. Also in the preferred embodiment, the output signals emitted by the signal emitter means will be in the radio-frequency range, and in particular embodiments will be in the range of 0 to 15 kHz.

Although the foregoing discussion has been in the specific context of treatment of liquids, other embodiments of the method may be used for treatment of gaseous or solid substances. For example, solid or substantially solid matter such as growing plants may be beneficially treated with selected electromagnetic wave signals in accordance with the present invention, for purposes such as enhancing plant growth or killing plant parasites. Other beneficial applications of the principles of the present invention will be readily apparent to persons skilled in the art of the invention.

### 3. Method of the Invention—Second Embodiment

In a second method according to the present invention, electromagnetic wave energy is utilized to treat a colloidal dispersion (i.e., suspensions) so as to alter selected properties of the dispersion to achieve desired beneficial effects. The dispersion being treated will commonly be a dispersion of particles in a continuous liquid medium, and the method will be further described herein in that context. However, the method may also be used in association with dispersions of particles (liquid or solid) in a continuous vapour or gaseous medium (steam, for example).

It is known that colloidal particle behaviour is related to the electrical charges acting on the particles. These charges may induce attractive forces or dispersion (i.e., repulsive) forces depending on the polarity of the charges associated with the particles. Several theories have been postulated to explain colloidal particle behaviour, notably including the DLVO (Derjaguin-Landau-Verwey-Overbeek) theory.

To maintain a colloidal suspension, the repulsive forces must be dominant; otherwise, the particles will be attracted to each other, and will agglomerate or flocculate and eventually precipitate out of the continuous medium. There are two primary mechanisms by which colloidal stability can be maintained, namely steric stabilization and electrostatic or charge stabilization.

In steric stabilization, a suitable polymer material is added to the suspension. The polymers adsorb onto the surfaces of the colloidal particles, thus imparting charges of the same polarity to all affected particles and thereby inducing repulsive forces between the particles, which therefore remain in suspension.

In electrostatic charge stabilization, the forces acting on the colloidal particles is influenced by altering the concentration of ions in the colloidal system. The “Zeta potential” of a colloidal dispersion is known to be an accurate indicator of the forces acting on and between the particles in the dispersion, and therefore is also a good indicator of colloidal stability. High zeta potentials, either negative or positive, will cause high repulsive forces between particles, which will therefore remain in suspension. Zeta potential is usually measured in millivolts (mV). In an aqueous dispersion, a zeta potential of +30 mV or more positive, or a zeta potential of −mV or more negative, generally will signify a stable dispersion. Where the zeta potential is between +30 mV and −30 mV, the dispersion will tend to be unstable (i.e., flocculation will occur), particularly as the zeta potential approaches zero. The zeta potential of a colloidal suspension is significantly affected by the pH (potential hydrogen) of the suspension. The pH value of a liquid is generally in the range of 0 to 14. A pH value of 7 is neutral; pH values below 7 denote acidity, and pH values above 7 denote alkalinity.

It is known that when alkaline materials are added to a colloidal suspension, the particles tend to acquire more negative charge, while the addition of acidic materials tends to increase positive charge on the particles. Accordingly, zeta potential will be positive when pH is low, and negative when pH is high.

It can be appreciated from the foregoing that changes in zeta potential will affect the pH of a colloidal suspension, as well as other properties such as viscosity and surface tension, which also relate to the forces acting on the particles in the suspension.

It is desirable in various industrial applications, and for various reasons, to alter the characteristics of a colloidal suspension. Effluent from industrial process plants often contain suspended materials that it is desirable to remove from the effluent; this is commonly done by adding flocculent materials that induce settling or precipitation of the particles. A particular example would be the tailings produced in the manufacture of synthetic crude oil from oil sands, such as are found in great quantities in northern Alberta, Canada. It has been estimated that the production of one barrel of synthetic crude entails the processing of 2.0 metric tons of oil sand, producing about 1.8 metric tons of solid tailings and about 2.0 cubic meters of waste water. The solid tailings contain high concentrations of fine clay minerals that are readily dispersed in the waste water, along with unrecovered bitumen. The resultant sludge creates a major disposal problem, as it is very difficult to remove the suspended particulate matter.

In some cases it may be desired to maintain colloidal stability and prevent precipitation. In other cases it may be desired to alter the pH, viscosity, or surface tension properties of a colloidal suspension to achieve desired benefits. These objectives may be achieved by adding selected chemicals or other substances (e.g., flocculants; surfactants; alkaline minerals; acids) to the suspension.

In contrast, the present method addresses the foregoing objectives by changing the electrical charge “signature” of the colloidal suspension so as to induce the desired changes in the properties of the suspension. It has been observed that the zeta potential of a colloidal suspension can be altered by exposure to electromagnetic wave energy, and that for a given suspension of particular compositional make-up, there will be electromagnetic frequencies that generally correspond to particular zeta potentials in the suspension. Therefore, if the properties of a given suspension are known or quantifiable or qualitatively assessable for different zeta potentials, and if the electromagnetic frequencies corresponding to different zeta potentials are known, it becomes feasible to treat the suspension by exposure to electromagnetic wave signals of selected frequencies corresponding to desired target zeta potentials, which in turn correspond to desired characteristics or properties of the suspension.

Accordingly, the first step in the second method of the present invention is to obtain a sample of the particular colloidal dispersion to be treated (for example, tailings sludge from an oil sands plant). The sample is evaluated by exposing it to a series of electromagnetic wave signals of varying frequencies for selected periods of time. During and/or at the end of the exposure for each frequency, the zeta potential of the sample is measured and recorded. At the same time, selected dispersion properties (such as, but not limited to) pH, viscosity, and surface tension) are measured (or otherwise characterized) and recorded. This process establishes a dispersion-specific data bank correlating zeta potential to specific electromagnetic wave frequencies and specific values or characterizations of selected properties of the specific colloidal dispersion.

The next stage of the method is the practical application of this dispersion-specific information to treat a colloidal dispersion having properties substantially the same as the test sample (e.g., a larger volume of oil sand tailings), so as to impart desired characteristics to the dispersion. From the data collected in the testing of the sample, a desired property is selected, and a desired value for that property is selected. For example, it might be desired, for some reason or another, to change the pH of the dispersion to 8.0. From the data bank, the zeta potential corresponding to a pH of 8.0 is determined, along with the corresponding electromagnetic wave frequency. The next step is to engage electromagnetic wave generating means so as to generate wave signals of the selected frequency (the “treatment frequency”) and introduce these wave signals to the dispersion being treated, using signal emitter means suitable to the application. In some cases, the signal emitter means may take the form of one or more immersion probes, while in others it may take the form of a transmitting antenna.

The zeta potential of the dispersion is monitored as the exposure to the electromagnetic wave signals continues. Once the target zeta potential is reached, the electromagnetic wave exposure can be continued as long as desired to maintain the particular properties or characteristics that have been achieved.

In alternative embodiments, the method may include the step of neutralizing the electrical charges present in the dispersion sample, such as by degaussing in accordance with known technology. It has been found that this step may in certain circumstances enhance the measurement and evaluation of the effects of the sample's exposure to electromagnetic waves. In a further alternative embodiment, the sample may be exposed to alternating current signals with frequencies in the range between about 20 and 1000 kiloHertz.

The measuring or monitoring of zeta potential, either at the sample stage or the practical application stage, may be carried out using any suitable known method. In the preferred embodiments, however, this step uses electrophoretic or electroacoustic measurement methods.

In the preferred embodiment of the method, the electromagnetic wave signals are analog signals. In alternative embodiments, the electromagnetic wave signals are digital signals.

Beneficial results may also be obtained by transmitting the electromagnetic wave signals to the dispersion as intermittently pulsed signals. Further beneficial results may be obtained by exposing the dispersion to wave signals having frequencies that are harmonics (i.e., integral multiples) of the treatment frequency.

It will be readily appreciated by those skilled in the art that various modifications of the apparatus and methods of the present invention may be devised without departing from the essential concept of the invention, and all such modifications are intended to be included in the scope of the claims appended hereto.

In this patent document, the word “comprising” is used in its non-limiting sense to mean that items following that word are included, but items not specifically mentioned are not excluded. A reference to an element by the indefinite article “a” does not exclude the possibility that more than one of the element is present, unless the context clearly requires that there be one and only one such element.

1. Apparatus for treating a substance with electromagnetic wave signals, said apparatus comprising:
(a) wave signal generator means;
(b) signal delivery means comprising:
b.1 a pair of primary conductors electrically connected to the wave signal generator means; and
b.2 a secondary conductor electrically connected to both primary conductors; and
(c) signal emitter means associated with the secondary conductor;
wherein:
(d) the wave signal generator means is controllable to generate electromagnetic wave signals of selected frequencies and amplitudes in the radio-frequency range;
(e) the wave signal generator means is capable of inducing a carrier wave signal of substantially constant frequency within the radio-frequency range in one of the primary conductors while inducing a variable-frequency wave signal within the radio-frequency range in the other primary conductor; and
(f) the carrier wave signal and the variable-frequency signal will combine to form an output signal carried by the secondary conductor to the signal emitter means.

2. The apparatus of claim 1 wherein the wave signal generator means comprises a microcomputer having at least one programmable computer chip.

3. The apparatus of claim 1 wherein the primary and secondary conductors comprise insulated, electrically-conductive wire.

4. The apparatus of claim 1 wherein the electrical connection between the primary conductors and the wave signal generator means is a wireless connection.

5. The apparatus of claim 4, further comprising a signal receiver, for receiving carrier wave signals and variable-frequency wave signals wirelessly transmitted from a telecommunications network and directing the received wave signals to the primary conductors.

6. The apparatus of claim 1, further comprising a direct-current coil disposed around at least a portion of the signal delivery means, whereby output signals carried by the secondary conductor may be oriented as either positive or negative signals depending on the direction of electrical current passing through the coil.

7. The apparatus of claim 6, further comprising means for selectively changing the polarity of the direct current circulating through the coil.

8. The apparatus of claim 1, further comprising pulsing means whereby output signals may be propagated from the signal emitter means in intermittent pulses.

9. The apparatus of claim 8, further comprising randomizing means, for pulsing the output signals randomly.

10. The apparatus of claim 1 wherein the signal emitter means comprises an immersion probe.

11. The apparatus of claim 10 wherein the secondary conductor serves as the immersion probe.

12. The apparatus of claim 10 wherein at least two signal delivery means are provided, and wherein the secondary conductors of the signal delivery means are braided together, with the braided secondary conductors serving as the immersion probe.

13. The apparatus of claim 1, further comprising a plurality of flow vanes mountable on the interior surface of a conduit, at least one of said flow vanes comprising an electrically-conductive element electrically connected to the secondary conductor, said electrically-conductive element or elements serving as the signal emitter means.

14. The apparatus of claim 13 wherein each flow vane having an electrically-conductive element further comprises a nonconductive insulating element, for insulating the electrically-conductive element from the conduit.

15. The apparatus of claim 13 wherein one or more of the flow vanes are configured so as to induce swirling flow in a liquid flowing through the conduit.

16. The apparatus of claim 1 wherein the signal emitter means comprises a transmitting antenna.

17. The apparatus of claim 16 wherein the transmitting antenna comprises a carbon rod about which one or more primary conductors are wrapped.

18. The apparatus of claim 16 wherein the transmitting antenna comprises a carbon rod about which one or more secondary conductors are wrapped.

19. The apparatus of claim 16 wherein the transmitting antenna comprises a carbon rod with a copper coating.

20. A method for treating a substance with electromagnetic wave energy, said method comprising the steps of:
(a) providing wave signal generator means adapted to generate constant-frequency and variable-frequency electromagnetic wave signals in the radio-frequency range;
(b) providing signal delivery means comprising:
b.1 a pair of primary conductors electrically connected to the wave signal generator means; and
b.2 a secondary conductor electrically connected to both primary conductors;
(c) providing signal emitter means associated with the secondary conductor;
(d) selecting one or more combinations of wave characteristics for a carrier wave signal of substantially constant frequency;
(e) selecting one or more combinations of wave characteristics for a variable-frequency wave signal;
(f) actuating the wave signal generator means to induce a carrier wave signal having the selected characteristics in one of the primary conductors;
(g) actuating the wave signal generator means to induce a variable-frequency wave signal having the selected characteristics in the other primary conductor; and
(h) engaging the signal emitter means with the substance to be treated, such that the substance is exposed to an output wave signal from the secondary conductor, said output signal being the combined form of the carrier wave signal and the variable-frequency wave signal.

21. The method of claim 20 wherein the substance to be treated is a liquid.

22. The method of claim 21, further comprising the steps of:
(a) determining the constituents of the liquid using spectral analysis;
(b) selecting a target constituent; and
(c) determining an energy absorption frequency for the target constituent; and wherein the selected wave characteristics for either or both of the carrier wave signal and the variable-frequency signal include the energy absorption frequency of the target constituent.

23. The method of claim 22 wherein the selected wave characteristics for either or both of the carrier wave signal and the variable-frequency signal include one or more harmonic frequencies corresponding to the energy absorption frequency of the target constituent.

24. The method of claim 22 wherein the means of spectral analysis used in the step of determining the constituents of the liquid to be treated includes means selected from the group consisting of chromatography, nuclear magnetic resonance spectroscopy, and magnetic resonance imaging.

25. The method of claim 22 wherein the step of determining the constituents of the liquid to be treated includes the further step of comparing the spectral analysis for the liquid to be treated against a spectral analysis for a known control liquid.

26. The method of claim 20, further comprising step of disposing a direct-current coil around at least a portion of the signal delivery means.

27. The method of claim 26, further comprising the step of providing means for selectively changing the polarity of the direct current circulating through the coil.

28. The method of claim 20, wherein the output signals are in the frequency range between 0.1 and 15 kiloHertz.

29. The method of claim 20, wherein the output signal is propagated from the signal emitter means in intermittent pulses.

30. The method of claim 29, wherein the output signal is randomly pulsed.

31. The method of claim 20, wherein the signal emitter means comprises an immersion probe.

32. The method of claim 20, wherein the signal emitter means comprises a transmitting antenna.

33. A method for treating a colloidal dispersion so as to alter selected properties thereof, said method comprising the steps of:
(a) obtaining a sample of the colloidal dispersion to be treated;
(b) exposing the sample to a selected number of electromagnetic wave signals of varying frequencies, the sample being separately exposed to each wave signal for a selected exposure period;
(c) measuring and recording the zeta potential value of the sample at the end of each exposure period, with reference to the corresponding wave signal frequency;
(d) measuring the value of one or more selected properties of the dispersion at the end of each exposure period for each wave signal frequency;
(e) selecting a value for a selected property from the values measured in step (d);
(f) determining the zeta potential value corresponding to the dispersion property value selected in step (e), from the zeta potential values recorded in step (c);
(g) determining the wave signal frequency corresponding to the zeta potential value determined in step (f), from the wave signal frequencies recorded in step (c);
(h) exposing the colloidal dispersion to electromagnetic wave signals having frequencies approximately equal to the wave signal frequency determined in step (g); and
(i) measuring the zeta potential of the dispersion at selected time intervals until the measured zeta potential is approximately equal to the value determined in step (g).

34. The method of claim 33 wherein the one or more selected properties referred to in step (d) include the viscosity of the dispersion.

35. The method of claim 33 wherein the one or more selected properties referred to in step (d) include the pH of the dispersion.

36. The method of claim 33 wherein the one or more selected properties referred to in step (d) include the surface tension of the dispersion.

37. The method of claim 33 wherein the colloidal suspension to be treated is a suspension of solid particles in a liquid.

38. The method of claim 37 wherein the liquid is an aqueous liquid.

39. The method of claim 33 wherein the colloidal suspension to be treated is a suspension of solid or liquid particles in a vapour.

40. The method of claim 39 wherein the vapour comprises steam.

41. The method of claim 33 wherein step (c) is carried out using electrophoretic measurement methods.

42. The method of claim 33 wherein step (c) is carried out using electroacoustic measurement methods.

43. The method of claim 33 comprising the further step of magnetically neutralizing the sample prior to step (b).

44. The method of claim 33 comprising the further step of exposing the dispersion to alternating current signals with frequencies in the range between about 20 and 1000 kiloHertz.

45. The method of claim 33 wherein the electromagnetic wave signals of step (h) are intermittently pulsed signals.

46. The method of claim 33 wherein the electromagnetic wave signals of step (h) are intermittently pulsed signals.

47. The method of claim 33 wherein the electromagnetic wave signals of step (h) are analog wave signals.

48. The method of claim 33 wherein the electromagnetic wave signals of step (h) are digital wave signals.

49. The method of claim 33 wherein step (h) includes the further step of exposing the colloidal dispersion to electromagnetic wave signals having frequencies that are harmonics of the the wave signal frequency determined in step (g).
